(19) United States
(12) Patent Application Publication
(10) Pub. No.: US 2004/0000985 A1
(43) Pub. Date: Jan. 1, 2004

(54) Sliding-type electric component including carbon fiber contact

(75) Inventor: Hisashi Komatsu, Miyagi-ken (JP)

Correspondence Address: BEYER WEAVER & THOMAS LLP, P.O. BOX 778, BERKELEY, CA, 94704-0778, US

(73) Assignee: ALPS ELECTRIC CO., LTD.

(21) Appl. No.: 10/461,121

(22) Filed: Jun. 13, 2003

(30) Foreign Application Priority Data
Jun. 26, 2002 (JP) 2002-186734
Jun. 26, 2002 (JP) 2002-186735

(51) Int. Cl. H01C 10/32

(52) U.S. Cl. 338/202; 338/162

(57) ABSTRACT

A sliding-type electric component includes a contact element. The contact element including a bundle of carbon fibers, and a sliding portion formed on the side portion thereof. The sliding portion being capable of linear contact or surface contact with a track of a conductive pattern.

### BACKGROUND OF THE INVENTION

1. Field of the Invention

The present invention relates to a sliding-type electric component used for a potentiometer or the like of an automotive vehicle, and to a technology to enable reduction of conductive resistance in a conducting route and provision of highly reliable products.

2. Description of the Related Art

Hitherto, a carbon sliding element including carbon fibers 103 held by a conductive holding member 101 formed of a metal plate in a bundled state for reducing generation of sliding noise at the sliding contact member, and the carbon fibers 103 in the bundled state are attached to a sliding element arm 105 as shown in FIG. 24, so that an end of the carbon fibers 103 can be brought into sliding contact with a resistive element 108 on a substrate 107 is known.

The carbon sliding element in this construction is characterized in that there are a number of contact points since the tip of a bundle of the carbon fibers slides with respect to the resistive element 108, and thus it is not necessary to increase the pressure at the contact points, and sliding noise is low, and little ground powder is generated from the resistive element 108.

However, in the construction of the sliding contact point including the carbon sliding element shown in FIG. 24, since the tip of the bundle of carbon fibers slides with respect to the resistive element 108, the edge at the tip of the bundle of carbon fibers may grind the resistive element 108. Therefore, generation of a slight amount of ground powder on the surface of the resistive element 108 after repeated sliding movements cannot be avoided.

In addition, when sliding the tip of the bundle of carbon fibers in a reciprocating manner with respect to the resistive element 108, part of the tip of the bundle of carbon fibers, which is in contact with the resistive element 108, is slightly bent in the direction opposite to the direction of outward movement when moving outward and is slightly bent in the direction opposite to the direction of inward movement when moving inward while the bundle of the carbon fiber moves along the surface of the resistive element 108. Therefore, the bending direction of the tip of the bundle of carbon fibers, which is in contact with the resistive element 108, during the outward movement is opposite to that during the inward movement. Consequently, when values of resistance at the positions where the tip of the bundle of carbon fibers is in contact with the resistive element 108 are detected, a slight hysteresis may be observed disadvantageously in the detected values of resistance depending on the direction of movement of the bundle of carbon fibers, that is, outward and inward.

In view of such circumstances, one of the objects of the present invention is to provide a highly reliable sliding contact member, in which assemble is easy, the conducting route includes the small number of conducting points and thus is low in conducting resistance, an output terminal thereof can be connected to a track, and possibility of occurrence of noise is low, as well as a sliding-type electric component and a sensor having such a sliding contact member.

As another construction of the sliding element of this type, a construction in which a recessed storage section 113 is formed on a rotor 111 shown in FIG. 25, and a rubber resilient body 114 and a contact shoe 115 are stored in the storage section 113, so that the contact shoe 115 is capable of a sliding movement with respect to the layer of resistive element 117 and the layer of conductive element 118 formed on an alumina substrate 116 is known.

The contact shoe 115 of the sliding element is constructed in such a manner that, as shown in a enlarged view in FIG. 26, a number of carbon fibers 112 dispersedly and closely disposed in the same direction are fixedly held by a conductive resin compact 119, the carbon fibers 112 are slid with respect to the layer of resistive element 117 and the layer of conductive element 118, a metal foil 120 is disposed on the bottom side of the storage section 113 so that the metal foil 120 comes into contact with a plurality of carbon fibers 112 positioned on the bottom side for obtaining good conductivity between the carbon fibers. The alumina substrate 116 is formed with lead terminals 121, 122 to be connected to the layer of resistive element 117 and the layer of conductive element 118, respectively, as shown in FIG. 25.

In the sliding element constructed as shown in FIG. 25 and FIG. 26, since separate carbon fibers slide with respect to the layer of resistive element 117 and the layer of conductive element 118 from among a plurality of carbon fibers 112, which slide with respect to the layer of resistive element 117 and the layer of conductive element 118, and a resin compact, which is relatively high in resistance is disposed between those separate carbon fibers 112 so as to connect, the sliding resistance increases. However, in order to avoid such a problem, a metal foil 120 for electrically connecting the plurality of carbon fibers 112 is provided. Therefore, even when the resistance of the conductive resin compact 119, which holds the carbon fiber 112, cannot be satisfactorily lowered, the metal foil 120 is connected in parallel with the resin compact 119 in terms of a circuit, a sufficiently low resistance is achieved.

However, in the construction of a sliding contact member shown in FIG. 25 and FIG. 26, since there are many connecting points in the conducting route for electrically connecting a layer of resistive element 117 and a layer of conductive element 118, there are problems in that it is difficult to connect definitely, and in that the number of components for constituting the conducting route increases as well. There is another problem in that the number of steps of assembly increases as a result of increase in number of components, whereby it takes time and efforts for manufacturing the sliding contact member. In addition, since the contact points between the carbon fibers 112 and the metal foil 120 and the metal foil 120, as well as the carbon fibers 112, are included in the main conducting route, a plurality of contact elements exist in the conducting route, and thus the resistance of the conducting route is liable to increase due to their contact resistances.

In view of such circumstances, one of the objects of the present invention is to provide a highly reliable sliding contact member, in which assemble is easy, the conducting route includes the small number of conducting points and thus is low in conducting resistance, an output terminal thereof can be connected to a track, and possibility of occurrence of noise is low, as well as a sliding-type electric component and a sensor having such a sliding contact member.

### SUMMARY OF THE INVENTION

In order to solve the problem described above, a sliding-type electric component includes a contact element, the contact element comprising a bundle of carbon fibers and a sliding portion formed on the side portion thereof, and the sliding portion is capable of linear contact or surface contact with a track of a conductive pattern. Since the bundle of carbon fibers slides with respect to the track of the conductive pattern on its side portion, the operation to grind the track is reduced in comparison with a case in which the tips or the edges of the carbon fibers slide in an upright state with respect to the track, and thus the track is prevented from being ground easily and progress of wear of the track is slowed down. Therefore, when repeated reciprocated sliding movement is made, sliding characteristic of the contact element with respect to the track is stabilized, and thus the sliding contact can withstand longer period of use. In addition, since the side surface of the carbon fiber is softer than the tip and is smoother because no edge portion is present, the conductive pattern can be prevented from being ground easily.

When the side portion of the bundle of carbon fibers is slid with respect to the track, a fixed side portion of the bundle of carbon fibers can be constantly slid with respect to the track on both routes; outward and inward, during reciprocating movement. Therefore, no hysteresis is observed in the output of resistance during the sliding movement. In other words, the problem of hysteresis can be reduced in comparison with the case in which the tips of the carbon fibers slide in an upright state with respect to the track. In addition, reduction of noise is achieved by using a bundle of carbon fiber. The track of the conductive pattern applied herein may be any of a layer of resistive element, a conductive layer, a collector layer, a metallic layer, and may be a combination thereof or a laminated layer.

When a contact element including a bundle of carbon fibers bent into a bifurcated shape, and sliding portions, which slide with respect to a conductive pattern formed with a pair of tracks thereon, at the side portions of both ends of the carbon fibers on the side opposite to the bending side is provided, since the sliding portions which slide with respect to the conductive pattern having the pair of tracks are formed at both ends of the bundle of the carbon fibers in a bent state, the pair of tracks can be connected with each other only by the bundle of carbon fibers. Since the pair of tracks are reliably connected with each other without providing additional member between the pair of tracks, the pair of tracks can reliably be connected. Consequently, the number of contact point in the conducting route may be reduced, and thus a stable and reliable sliding contact member with low resistance is achieved. In addition, since the reliable connection with low resistance as described above is achieved at the sliding contact member only by the bundle of carbon fibers in a bent state, the number of components may be reduced. Since the number of the components is small, the number of steps during assembly can be reduced. An output terminal can be connected to the track on which the bundle of the carbon fibers slides, and thus it is no more necessary to perceive signals from the carbon fiber. The track applied herein may be any of a layer of resistive element, a layer of conductive element, a collector layer, and a metallic layer, and may be a combination thereof or a laminated layer. The bifurcated shape includes various shapes formed by bending the bundle of carbon fibers to an extent without being broken, such as U-shape, C-shape, J-shape, Ω-shape, ω-shape, V-shape bent into a gentle angle, L-shape, N-shape bent into gentle angles, S-shape, or arcuate shape.

The bundle of carbon fibers is bent in a state in which both ends thereof are supported, and part of the side portion of the bent section serves as a sliding portion. The carbon fiber is originally soft and flexible. However, it is preferable to add rigidity to the carbon fibers for ensuring reliable contact during the sliding movement. When the bundle of carbon fiber is supported in a state in which both ends thereof are supported and bent, rigidity of the carbon fiber increases. As a consequent, when the bundle of carbon fibers is reciprocated in a state of being in contact with the track, hysteresis can hardly occur during outward and inward movements. In addition, since rigidity of the carbon fibers increases by supporting both ends of the carbon fibers, the carbon fibers are prevented from being bent or broken.

In addition, a contact element, which is a bundle of carbon fibers bent into a bifurcated shape and is formed with a sliding portion to be slid with respect to the pair of tracks, is provided on the portion except for the both end portions on the side opposite from the bent section. In this case, since the sliding portion of the bundle of carbon fibers, which slide with respect to the conductive pattern having the pair of tracks, is formed on the portion of the bundle of carbon fibers in a bent state except for the both ends thereof, the pair of tracks can be connected by the bundle of carbon fibers, and the pair of tracks can reliably be connected with each other without providing additional member between the tracks. Consequently, the number of contact points in the conducting route can be reduced, and thus a highly reliable sliding contact member, which is low in resistance and thus stable. In addition, since the reliable connection as described above is achieved at the sliding contact member only by the bundle of carbon fibers in a bent state, the number of components may be reduced. Since the number of the components is small, the number of steps during assembly can be reduced. The output terminal can be connected to the track on which the bundle of the carbon fibers slides, and thus it is no more necessary to perceive signals from the carbon fiber.

In order to solve the problem described above, the sliding-type electric component of the present invention includes a contact element, characterized in that the contact element includes a sliding portion formed by covering at least part of the bundle of carbon fibers with a covering layer, the sliding portion is with respect to the tracks of the conductive pattern. The carbon fibers do not come into contact directly with the track, but the covering layer comes into contact with the track. Therefore, the edges at the tips of the carbon fiber do not come into contact with the track of the conductive pattern, thus the possibility that the track is ground is further reduced and progress of wear of the track is slowed down. In addition, the covering layer can protect the carbon fibers themselves. The track applied here may be any one of a layer of resistive element, a layer of conductive element, a layer of collector, and a metallic layer, or may be a laminated layer thereof.

When the covering layer is formed of synthetic resin with conducting properties mixed therein, conducting properties during the sliding movement with respect to the track when sliding with respect to the track are improved. Even when the covering layer is worn, and the carbon fibers are exposed, since the satisfactory conduction is achieved through the carbon fibers, and thus deterioration of characteristics during the sliding movement after the covering layer has worn is prevented.

When the sliding portion to be slid with respect to the track of the conductive pattern is provided on the side of the covering layer, a certain side portion of the covering layer, which covers the bundle of carbon fibers, constantly slides with respect to the track, no hysteresis occurs in the output of resistance during the sliding movement in contrast to the case in which the tips of the carbon fibers are slid with respect to the track.

In order to solve the problem described above, the sliding-type electric component according to the present invention includes a contact element, and is characterized in that the contact element is a bundle of carbon fibers bent into a bifurcated shape, and the carbon fibers are formed with sliding portions to be slid with respect to a conductive pattern having a pair of tracks at both end on the side opposite to the bent section, in that the bundle of carbon fibers as the contact element is covered with a holding member at least partly or entirely of the portion thereof except for the sliding portion in a state of being exposed, and in that the holding member constrains and integrates the bundle of carbon fibers at least partly or entirely. In other words, since the sliding portions which slide with respect to the conductive pattern having a pair of tracks are formed on both ends of the bundle of the carbon fibers in a bent state, the pair of tracks can be connected with each other only via the bundle of carbon fibers. Therefore, since no member is interposed between the pair of tracks, the pair of tracks are reliably connected with each other, whereby the number of contact elements in the conducting route can be reduced and a stable and reliable sliding contact member with low resistance is achieved. In addition, since the reliable connection with low resistance as described above is achieved at the sliding contact member only by the bundle of carbon fibers in a bent state, the number of components may be reduced. Since the number of the components is small, the number of steps during assembly can be reduced. Since an output terminal can be connected to the track on which the bundle of the carbon fibers slides, it is no more necessary to perceive signals from the carbon fiber. The track applied herein may be any of the layer of resistive element, the conductive layer, the collector layer, the metallic layer, and may be the combination thereof or the laminated layer. The shape of the track in plan view may be any shape as long as the contact element can be slid, including a rectangular shape, a comb shape, an arcuate shape, and a rectangular wave shape. On the other hand, since the bifurcated shape includes all the shapes formed by bending the bundle of carbon fibers to an extent without being broken, various shapes such as U-shape, C-shape, J-shape, Ω-shape, ω-shape, V-shape bent into a gentle angle, L-shape, N-shape bent into gentle angles, S-shape, or arcuate shape are included. Since at least part of the bundle of carbon fibers except for the sliding portions is covered by the holding member, the shape of the bundle of carbon fibers in the bundled and bent state can reliably maintained, and the exposed sliding portions of the bundle of carbon fibers can reliably slide with respect to the tracks. Since the shape of the bundle of carbon fibers can be maintained by the holding member, the shape of the bundle of carbon fibers can reliably maintained. Maintenance of the shape of the bundle of carbon fibers is achieved by covering at least part of the bent bundle of carbon fibers except for the sliding portion thereof by the holding member, which is a separate member from the bundle of carbon fibers. Since the bundle of carbon fibers are constrained by the cylindrical holding member, the shape of bundle of carbon fibers is reliably maintained. The cylindrical holding member may have such structure that one holding member constrains the bundle of carbon fibers, or a plurality of cylindrical holding members constrain the bundle of carbon fibers in a bent state cooperatively. Since the bundle of carbon fibers is constrained by the holding member and thus the shape thereof is maintained, the constrained state of the bundle of carbon fibers is prevented from getting out of order when the bundle of carbon fibers slides with respect to the pair of tracks, and thus a stable sliding movement with respect to the pair of tracks is achieved.

When the holding member is formed with flat portions at the ends positioned on the sides of the ends of the bundle of carbon fibers, the ends of the bundle of carbon fibers projected from the flat portions serve as sliding portions aligned in a flat shape, and both of the sliding portions are aligned widthwise of the tracks, with respect to which the both of the sliding portions slide respectively, the ends of the bundle of carbon fibers, being formed into a flat shape, can be slid in the uniform width with respect to the track of a predetermined width when the bundle of carbon fibers is slide with respect to the track of the conductive pattern, which contributes stability of the sliding state. In addition, since the length of the bundle of carbon fibers which comes into contact with the track along the length of the track can be reduced, a predetermined output can be obtained constantly.

When the shape of the bundle of carbon fibers is maintained into a bifurcated plate shape having an intermediate bent section by the holding member, it is easy to process the holding member to maintain the bundle of carbon fibers into a plate shape. It is also easy to slide the ends or other portions of the bundle of carbon fibers in this state with respect to the tracks. When the bent section is gently bent, the possibility of bending or breaking the bundle of carbon fibers may be avoided.

In order to solve the problem described above, a sliding-type electric component according to the invention includes a contact element, and the contact element includes the bundle of carbon fibers bent into a bifurcated shape and sliding portions, which slides with respect to the conductive pattern having the pair of tracks, at both ends of the carbon fiber opposite to the bent section, remaining portions covered by the holding member formed of a resin at least partly or entirely in a state in which the sliding portion of the bundle of carbon fibers of the contact element being exposed, and the contact element is formed by insert-molding the bundle of carbon fibers into the holding member.

Since at least part of the bundle of carbon fibers except for the sliding portions is covered by the holding member, the shape of the bundle of carbon fibers in the bundled and bent state can reliably maintained, and the exposed sliding portions of the bundle of carbon fibers can reliably slide with respect to the tracks. Since the shape of the bundle of carbon fibers can be maintained by the holding member, the shape of the bundle of carbon fibers can reliably maintained. In addition, since the shape of the bundle of carbon fibers can be maintained by the holding member by means of insert molding, maintenance of the shape of the bundle of carbon fibers is achieved easily. Maintenance of the shape of the bundle of carbon fibers is achieved by covering at least part of the portion of the bundle of carbon fibers in the bent state except for sliding portions of the bundle of carbon fiber with the holding member, which is a member different from the bundle of carbon fibers.

### BRIEF DESCRIPTION OF THE DRAWINGS

FIG. 1 is a perspective view showing a sliding contact member and a positional relationship between a sliding contact member with respect to the first track and the second track according to a sliding-type electric component of a first embodiment of the present invention;

FIG. 2 is a plan view of the sliding contact member of the sliding-type electric component shown in FIG. 1;

FIG. 3 is an explanatory perspective view illustrating a method of assembly of the sliding contact member shown in FIG. 2;

FIG. 4 is a perspective view of an intermediate compact obtained in the process of assembling the sliding contact member shown in FIG. 2;

FIG. 5 is a perspective view showing the sliding contact member in the last stage of the processing;

FIG. 6 is a side view showing an example of the shape of the end portion of the sliding contact member of the sliding-type electric component according to the present invention;

FIG. 7 is a side view showing another example of the shape of the end portion of a contact element of the sliding-type electric component according to the present invention;

FIG. 8 is a perspective view showing a positional relationship between the sliding contact member with respect to the first track and the second track according to a second embodiment of the present invention;

FIG. 9 is a perspective view showing another example of the mounting state of the sliding contact member according to a third embodiment of the present invention;

FIG. 10 is a perspective view of the sliding contact member according to a fourth embodiment of the present invention;

FIG. 11 is a perspective view of the sliding contact member according to a fifth embodiment of the present invention;

FIG. 12 is a perspective view of the sliding contact member according to a sixth embodiment of the present invention;

FIG. 13 is a perspective view showing an example of a method of manufacturing the sliding contact member according to a fifth embodiment of the present invention;

FIG. 14 is a perspective view showing an example at a method of manufacturing the sliding contact member according to a sixth embodiment of the present invention;

FIG. 15 is a cross-sectional view of the sliding contact member according to a seventh embodiment of the present invention;

FIG. 16 is a cross-sectional view of the sliding contact member according to a eighth embodiment of the present invention;

FIG. 17 is a cross-sectional view of the sliding contact member according to a ninth embodiment of the present invention;

FIG. 18 is a perspective view showing an example of a method of manufacturing the sliding contact member according to the present invention;

FIG. 19 is a partially enlarged view of the sliding contact element shown in FIG. 18;

FIG. 20 is a cross-sectional view showing an example of a worn state of the sliding contact member shown in FIG. 19;

FIG. 21 is a cross-sectional view showing an example of the contact element according to a tenth embodiment of the present invention;

FIG. 22 is a cross-sectional view showing an example of a sensor provided with the sliding contact member according to the present invention;

FIG. 23 is a side view of a part of the sensor shown in FIG. 22;

FIG. 24 is a drawing showing an example of a sliding element in the related art;

FIG. 25 is a drawing showing another example of a sliding element in the related art; and

FIG. 26 is a partly enlarged view showing a construction shown in FIG. 25.

### DESCRIPTION OF THE PREFERRED EMBODIMENT

Referring now to the drawings, embodiments of the present invention will be described. However, the present invention is not limited to the following embodiments.

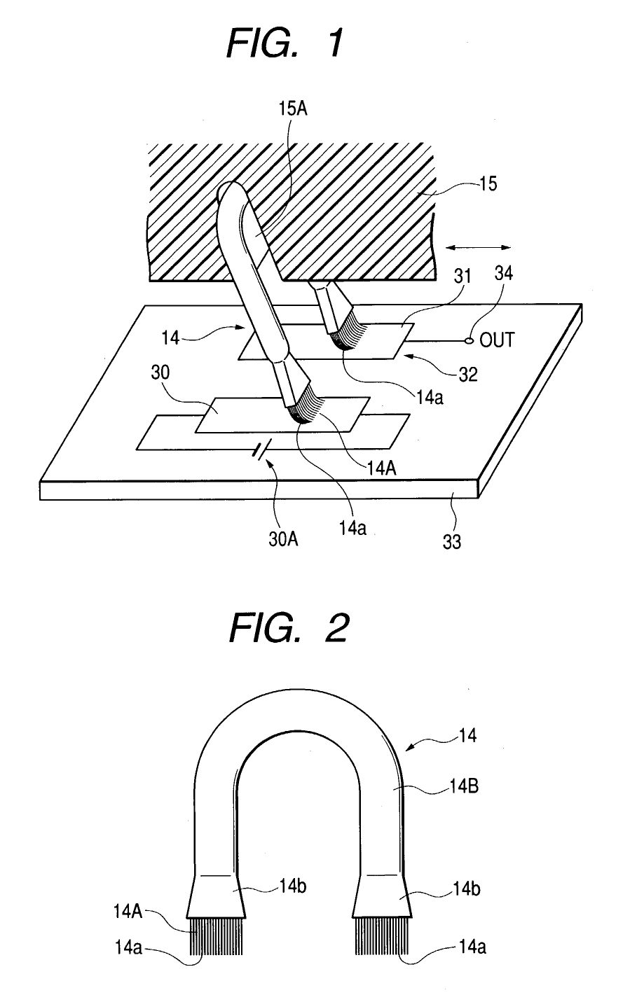

In FIG. 1, reference numeral 15 designates a sliding element support (supporting member) provided so as to be capable of reciprocating movement in the lateral direction in FIG. 1, which is formed with a recess 15A extending diagonally on the bottom of the sliding element support 15. A sliding contact member 14, which will be described later in detail, is attached to the recess 15A by fixing means such as adhesion or the like.

The sliding contact member 14 in this embodiment includes a bundle of carbon fibers 14A bent into a U-shape (bifurcated) as will be described later, and a holding member 14B formed into a U-shaped cylinder for constraining the bundle of carbon fibers 14A. The bundle of carbon fibers 14A bifurcated into a U-shape serves as the contact element (sliding element). The bifurcated shape includes various shapes formed by bending the bundle of carbon fibers to an extent without being broken, such as U-shape, C-shape, J-shape, Ω-shape, ω-shape, V-shape bent into a gentle angle, L-shape, N shape bent into gentle angles, S-shape, or arcuate shape.

The bundle of carbon fibers (contact element) 14A is formed by bundling, preferably, hundreds to thousands, for example, one thousand to two thousands of thin carbon fibers of several to several tens of micro meter, for example, in the order of 5 to 10 μm in diameter. The bundle of carbon fibers is bent into a U-shape, and the U-shape is maintained by a U-shaped holding member 14B formed of a metallic pipe that is capable of plastic deformation, such as a aluminum pipe, a brass pipe, or a stainless steel pipe, and both ends on the side opposite from the bent section, that is, the ends portions 14a, 14a of the bundle of carbon fibers 14A, project from both ends of the holding member 14B by a predetermined length and serve as sliding portions.

The both ends of the holding member 14B, which is formed of the aluminum pipe or the like, are formed into a flat shape by press work or the like to form a flat portion 14b for preventing the carbon fibers from coming off and shaping the contour of the carbon fibers. The end portions 14a, 14a at the extremities, which serve as sliding portions of the carbon fibers exposed from these flat portions 14b, project in alignment into a flat shape, respectively, so that the extremities of the carbon fibers projected independently at one end portion 14a and the other end portion 14a are disposed in parallel so as to be aligned in substantially the same plane.

In this example, the flat portions 14b are formed by plastically forming the both ends of the metallic pipe by pressing means such as a press into a flat shape so that the carbon fibers are aligned into a flat shape, and the both ends of the holding member 14B are broadened toward the ends during processing. However, the present invention is not limited to this shape, and the both ends do not have to be processed into a flat shape, as a matter of course.

The sliding contact member 14 formed as described above is formed by being inserted into the recess 15A extending diagonally downward formed on the bottom side of the sliding element support 15 by a half the length of the holding member 14B. The inserted portion is fixed to the recess 15A by fixing means such as adhesion, and is fixed to the bottom of the sliding element support 15 in a state in which the extremities of the ends 14a, 14a of the sliding contact member 14 are projected from the bottom of the sliding element support 15.

A conductive pattern 32 including a pair of first track 30 and a second track 31, each being a rectangular shape and arranged in parallel, is formed on a base member 33 such as a substrate downwardly of the sliding element support 15, that is, at the position facing the side portions at the end portions 14a, 14a at the extremities of the sliding contact member 14. The shape of the track in plan view may be any shape as long as the contact element can slide thereon, such as a rectangular shape, a comb shape, an arcuate shape, or a rectangular wave shape.

The side portions at the end portions 14a, 14a of the sliding contact member 14 are disposed so as to straddle widthwise of the first track 30 and the second track 31 on the base member 33 in substantially parallel with each other, and to be brought into contact with the upper surface of the track from diagonally above. In other words, one side portion at the end portions 14a of the bundle of carbon fibers 14A, which is flat in shape and the other side at the end portion portion 14a of the bundle of carbon fibers 14A are supported so as to keep in contact to, and slide along, the length of the tracks, respectively, in a state in which the width of one side portion at the end portion 14a is aligned with the width of the first track 30, and the width of the other side portion at the end portion 14a is aligned with the width of the second track 31.

The recess 15A is preferably formed diagonally with respect to the tracks 30, 31, so as to incline the end portions 14a of the bundle of carbon fibers 14A diagonally with respect to the tracks 30, 31. The angle of inclination is preferably included in a range between 20 to 60 degrees, for example, in the order of 30 degrees, but is not limited to the aforementioned range. However, it is necessary to set the angle to a small value so that the side portions to be brought into contact with the conductive pattern 32 do not vary in both route; outward and inward. In contrast, it is necessary to set the angle to a predetermined value or larger, so as to prevent the holding member 14B from coming into contact with the conductive pattern 32.

The sliding contact member 14, the first track 30, and the second track 31 constitute the sliding-type electric component, and the first track 30 and the bundle of carbon fibers 14A, and the second track 31 constitute the conductive route (electric path). The contact elements in this electric path exist at two positions, that is, the side portions at the end portions 14a, 14a of the bundle of carbon fibers 14A, which serve as sliding ends. A predetermined direct current is applied on the first track 30 from a predetermined power unit 30A, and an output terminal 34 is formed at one end of the second track 31.

The first track 30 is formed of a layer of resistive element constructed, for example, of a conductive element, such as carbon black or carbon fiber, and carbon nanotube, which mainly reinforces the layer of resistive element and reduces its coefficient of friction, and a polymer resistive element formed of thermoset resin, such as phenol resin or epoxy resin. The second track 31 is formed of a good conductor, for example, a conductive circuit formed by mixing conductive metallic material, such as copper foil or aluminum foil or the like, or a conductive element, such as silver powder, into a thermoset resin, so as to serve as a collector.

The layer of resistive element is formed by transfer printing or the like so as to obtain the roughness of the surface of 0.5 μm or below. Therefore, the carbon fiber is not liable to be caught by the layer of resistive element, and thus hysteresis that may occur during reciprocated movement can further be reduced.

The carbon black may be furnace black having relatively low conductivity (for example, ASAHI 60 from ASAHI CARBON Co., Ltd., RAVEN 150 from Columbian Chemicals Company, MA 100 from Mitsubishi Kasei KK). The carbon black may be conductive furnace black having relatively high conductivity (for example, KETJEN BLACK EC from LION CORPORATION), or acetylene black (for example DENKA BLACK from DENKI KAGAKU KOGYO KABUSHIKI KAISHA).

According to the sliding-type electric component constructed as described above, the sliding element support 15 reciprocally moves in parallel with the tracks 30, 31 in the lateral direction in FIG. 1. Therefore, the side portions at the end portions 14a, 14a of the sliding contact member 14 slide reciprocally with respect to the first track 30 and the second track 31,and an input voltage applied on the first track 30 is divided depending on the position of the sliding contact member 14 during the sliding movement, or more accurately, the position of the track with which the side portion at the end portions 14a comes into contact. Then, the position of the track with which the sliding contact member 14 is detected by measuring the output voltage, so that the position can be detected from the relative relationship between the output voltage and the position. The output voltage may be obtained by measuring the electric output from the output terminal 34 connected to the second track 31.

In the sliding-type electric component having the construction described above, the pair of tracks 30, 31 can be electrically connected reliably only via the bundle of carbon fibers 14A, and a metal foil 120 or a resin compact 119 formed of conductive resin, which constitute an electrical contact in the related art as shown in FIG. 28 and FIG. 29, are not necessary. Therefore, the number of connecting points required for constructing the sliding-type electric component by connecting the tracks 30, 31 may be reduced, and thus resistance in the conducting route is prevented from increased unnecessarily, which contributes reduction of conducting resistance.

In addition, since the two tracks 30, 31 can be electrically connected reliably only via the bundle of carbon fiber 14A, it is not necessary to perceive electric signals directly from the carbon fibers, and the electric signals can be perceived directly from the tracks 30, 31. In addition, since the metal foil 120 or the resin compact 119 are not necessary, the number of components can be reduced, which contributes simplification of the manufacturing process.

The side surface of the carbon fiber is less hard than the tip, and is smoother because no edge portion is present. Therefore, the conductive pattern can be prevented from being ground easily.

The bundle of carbon fibers 14A constructed as described above may be fabricated, for example, by a method described below.

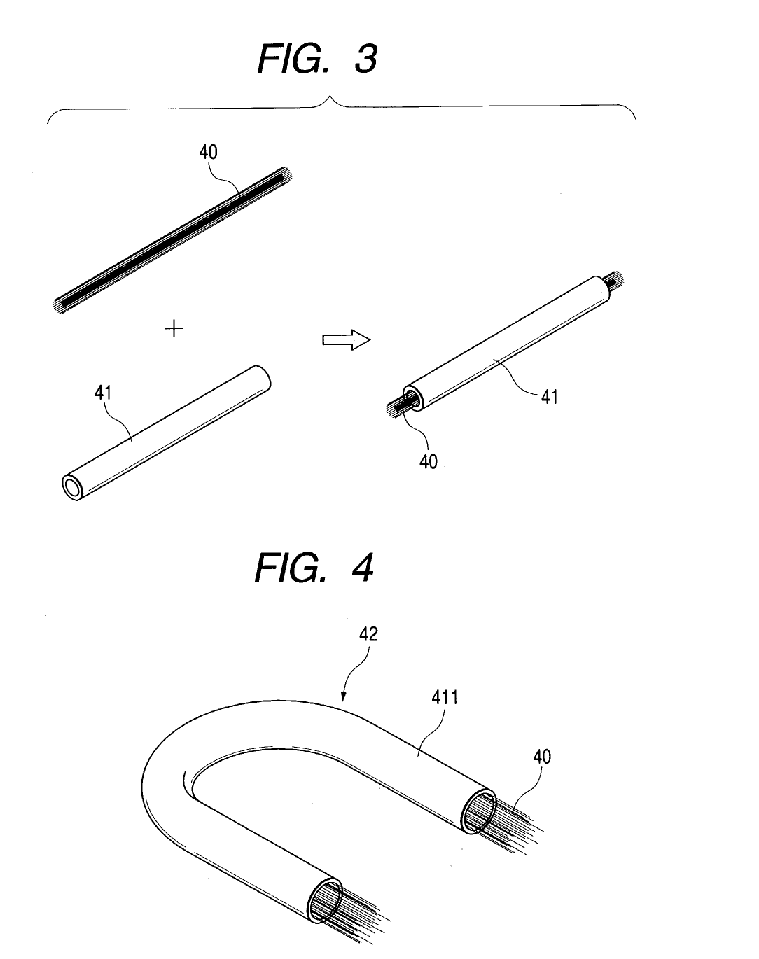

As shown in FIG. 3, when the required number of, for example, 1000 to 2000, carbon fibers 40 cut into a required length are bundled, the bundled carbon fibers 40 are inserted through an aluminum pipe 41, and the pipe 41 is plastically deformed into a U-shape to form a U-shaped tube 411, so that an intermediate compact 42 in a state in which a bundle of carbon fibers 40 are held into a U-shape is obtained.

Subsequently, the both ends of the U-shaped tube 411 are plastically deformed into a flat shape by press work, so that the U-shaped bundle of carbon fibers in a state of being constrained by the holding member 14B including flat portions 14b as shown in FIG. 5 is obtained. When the tips of the carbon fibers projected from the pipe 41 are not aligned, the tips of the carbon fibers may be cut along a cutting line S-S′ shown by a chain double-dashed line in FIG. 5 to obtain the bundle of carbon fibers (sliding contact member) 14A shown in FIG. 2. It is also possible to apply lubricant such as grease or oil on both ends of the bundle of carbon fibers 14A in this state before usage.

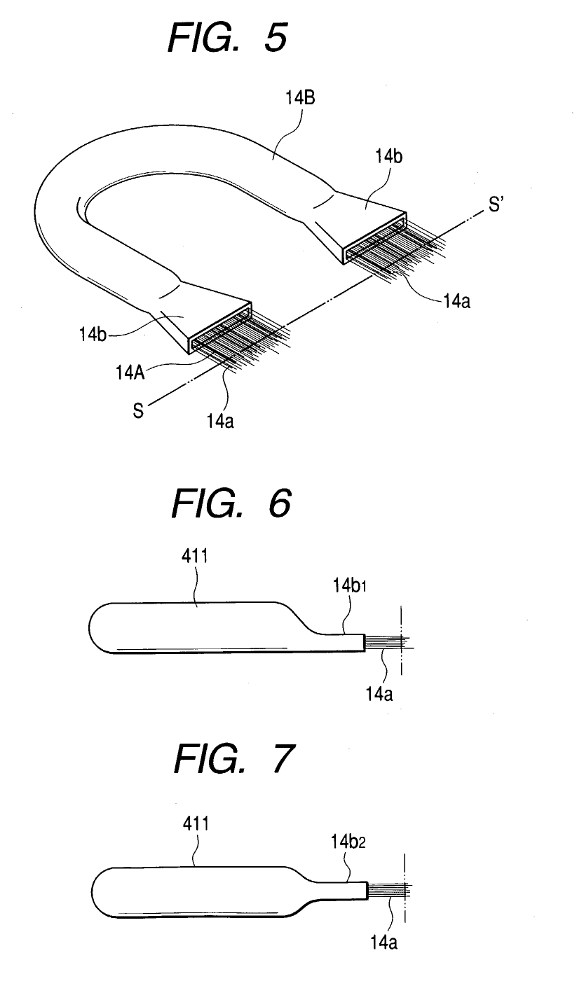

When forming the flat portions 14b by plastically deforming the U-shaped tube 411 shown in FIG. 4 by press work, the U-shaped tube 411 may be pressurized mainly by the press from one side in the direction of thickness of the U-shaped tube to form a flat portion 14b1 at the bottom side of the U-shaped tube 411 in the direction of thickness as shown in FIG. 6, or the U-shaped tube 411 may be pressurized from both sides in the direction of thickness to form a flat portion 14b2 at the center in the direction of thickness of the U-shaped tube 411 as shown in FIG. 7. The end portions of the bundle of the carbon fibers 14A after press work are preferably cut along the cutting line shown by a chain double dashed line to obtain a uniform length of projection in both cases shown in FIG. 6 and FIG. 7.

In this embodiment, since the holding member is bent, the carbon fibers are prevented from coming off in comparison with the case in which the holding member has a straight shape.

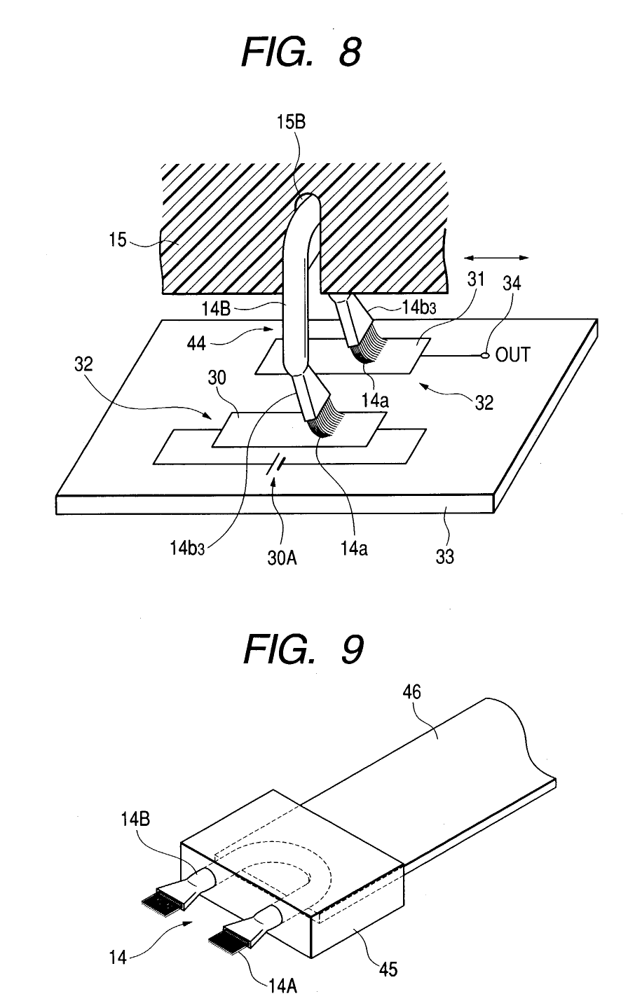

FIG. 8 shows a second embodiment of the sliding contact member according to the present invention. In this embodiment, the recess 15B, which is opened vertically downward, is formed on the sliding element support (supporting member) 15, and the U-shaped holding member 14B is fixed so as to face downward by fixing means such as adhesion or the like. A sliding contact member 44 is constructed in such a manner that a flat portion 14b3 of the holding member 14 is diagonally bent so that one end portion 14a of the bundle of carbon fibers 14A constituting the contact element comes into diagonal contact with track 30 of the first pattern 30 and the other end portion 14a comes into diagonal contact with the track 31 of the second pattern 31.

According to the sliding-type electric component including the sliding contact member 44 having the bundle of carbon fibers 14A as shown in FIG. 8, the first track 30, and the second track 31, similar effects to the case of the sliding-type electric components described in the above-described embodiment may be obtained.

Although the angle of bending of the flat portion 14b3 of the sliding contact member 44 may be selected on a voluntary basis, since it is necessary to bring the ends 14a of the bundle of carbon fibers 14A into diagonal contact with the tracks 30, 31, the ends 14a must simply be bent by at least an angle which is required for bringing the ends 14a into contact with the tracks 30, 31, for example, 20 to 60°.

FIG. 9 shows a third embodiment of the sliding contact member according to the present invention. In this embodiment, the sliding contact member 14 including the bundle of carbon fibers 14A and the U-shape cylindrical holding member 14B for constraining the bundle of carbon fibers 14A, which is bent into a U-shape (bifurcated) as in the first embodiment, is mounted to a mounting body 46 having a resiliency, such as a leaf spring, via a joint layer 45 including an adhesive layer or an insert molded layer.

The construction according to this embodiment brings about the similar effects to those described above in conjunction with the first embodiment by mounting the mounting body 46 to the recess 15A of the sliding element support 15 in the first embodiment by fixing means such as adhesion.

In this embodiment, since the mounting body 46 has a resiliency by itself, the side portions at the end portions 14a can be brought into resilient contact with the tracks 30, 31 easily without providing resiliency to the bundle of carbon fibers 14A.

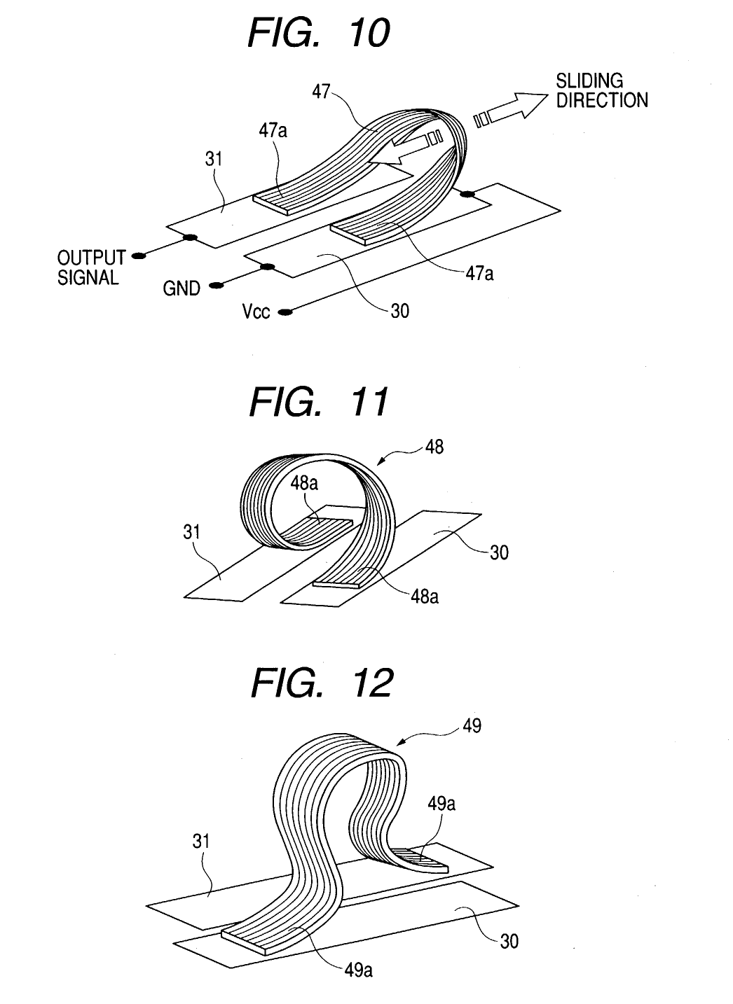

FIG. 10 shows a fourth embodiment of the sliding contact member according to the present invention. In this embodiment, the sliding contact member is constructed in such a manner that a contact element is formed by twisting and bending a bundle of carbon fibers 47 formed into a band shape at the lengthwise center thereof so that one end 47a and the other end 47a of the bundle of the carbon fibers 47 are constrained by the adhesive layer in a state of facing in the same direction, and the ends 47a, 47a of the bundle of carbon fibers 47 are brought into line contact with the first track 30 and the second track 31 in a state of facing in the same direction.

The bundle of carbon fibers 47 in a band shape in this embodiment may be maintained by covering the portion except for the ends thereof with a fixing layer such as an adhesive layer and curing it to maintain its shape, or may be maintained by employing shape holding means including the steps of inserting the bundle of carbon fibers 47 into the flat metal pipe to dispose the flat metal pipe around the bundle of the carbon fibers 47, and machining the flat metal pipe.

In this bundle of carbon fibers 47, the same effects as in the constructions in the preceding embodiments maybe achieved.

The possibility to bend and break the bundle of carbon fibers 47 may be avoided by bending the bundle of carbon fibers 47 into a gentle curve, so that the bundle of carbon fibers 47 is prevented from being applied with a load.

FIG. 11 shows a fifth embodiment of the sliding contact member according to the present invention. In this embodiment, the contact element is formed by turning a bundle of carbon fibers (contact element) 48 into a unispiral shape and constraining one end 48a and the other end 48a of the bundle of carbon fibers 48 in a state of facing alternately in the opposite directions. The sliding contact member is constructed by bringing the ends 48a and 48a of the bundle of carbon fibers 48 into line contact with the first track 30 and the second track 31 in a state of facing alternately in the opposite directions.

The bundle of carbon fibers 48 in a band shape in this embodiment may be covered at the portion except for the ends thereof by a fixing layer such as an adhesive layer and curing it to maintain its shape, or may be formed by curing with the fixing layer and maintaining its shape in a state of being wound around a column. It is also possible to maintain the shape holding means by employing shape holding means including the steps of inserting the bundle of carbon fibers 48 into the flat metal pipe to dispose the flat metal pipe around the bundle of the carbon fibers 48, and machining the flat metal pipe.

In this bundle of carbon fibers 48, the same effects as the constructions in the preceding embodiments may be achieved.

In the bundle of carbon fibers 48 in this embodiment, a construction in which the single bundle of carbon fibers 48 is slid with respect to the tracks 30, 31 in two different levels. This is achieved by changing the heights of the ends 48a, 48a by adjusting its twisted state, and, if the shape is maintained in a state in which one end 48a is disposed at the position higher than the other end 48a, setting the horizontal height of the second track 31 at the position higher than the horizontal height of the first track 30.

FIG. 12 shows a sixth embodiment of the sliding contact member according to the present invention. In this embodiment, the sliding contact member is constructed by forming the contact element by machining the bundle of carbon fibers (contact element) 49 into a substantially Ω-shape in side view, and constraining one end 49a and the other end 49a of the bundle of carbon fibers 49 in a state of facing alternately in the different directions, and bringing the ends 49a and 49a of the bundle of carbon fibers 49 positioned at different levels into line contact with the first track 30 and the second track 31 in a state of facing in the different directions with respect to each other.

The bundle of carbon fibers 49 in a band shape in this embodiment may be covered at the portion except for the ends thereof with the fixing layer such as the adhesive layer and cured to maintain its shape, or may be formed by inserting the bundle of carbon fibers 49 into the flat metal pipe, disposing the flat metal pipe around the bundle of the carbon fibers 49 and then maintaining the shape by employing shape holding means, such as machining the flat metal pipe and maintaining the shape.

In this bundle of carbon fibers 49a, the same effects as in the constructions in the preceding embodiments maybe achieved.

In this bundle of carbon fibers 49 in this embodiment, a construction in which the single bundle of carbon fibers 49 is slid with respect to the tracks 30, 31 in two different levels. This is achieved by changing the heights of the ends 49a, 49a by adjusting its twisted state, and, if the shape is maintained in a state in which one end 49a is disposed at the position higher than the other end 49a, setting the horizontal height of the second track 31 at the position higher than the horizontal height of the first track 30.

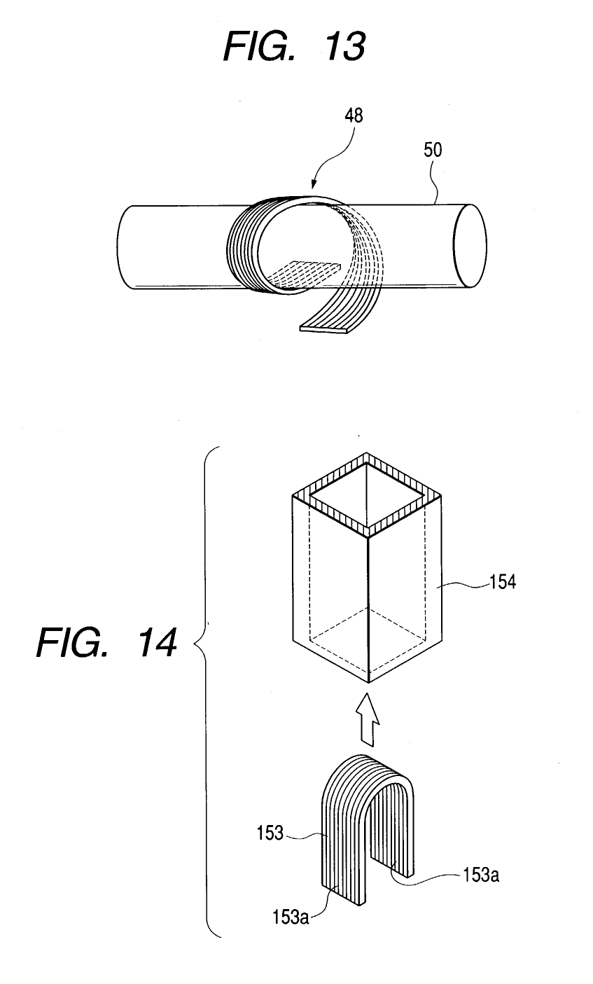

FIG. 13 shows an example of a method for manufacturing the bundle of carbon fibers 48 in the shape shown in FIG. 11. The flat-shaped bundle of carbon fibers is wound around a forming block 50 in a shape of a round rod, and maintained in this state by holding member, which is not shown in the drawing.

In this case, a method including the steps of winding the bundle of carbon fibers, which is procured by the adhesive layer preliminarily to a deformable extent, around the forming block 50, and then curing the adhesive layer to a fully hardened state, or a method including the steps of constraining the bundle of carbon fibers by a flat-shaped pipe and bending the pipe, may also be applied.

Alternatively, as shown in FIG. 14, the contact element may be formed by inserting a bundle of carbon fibers (contact element) 153 machined into a U-shape into the bottom of an angular tube shaped supporting member 154, and fixing both ends 153a, 153a of the bundle of carbon fiber 153 by adhesion in a state of slightly projecting from the opening of the supporting member 154. In this construction, the carbon fibers can easily be held in the bent state.

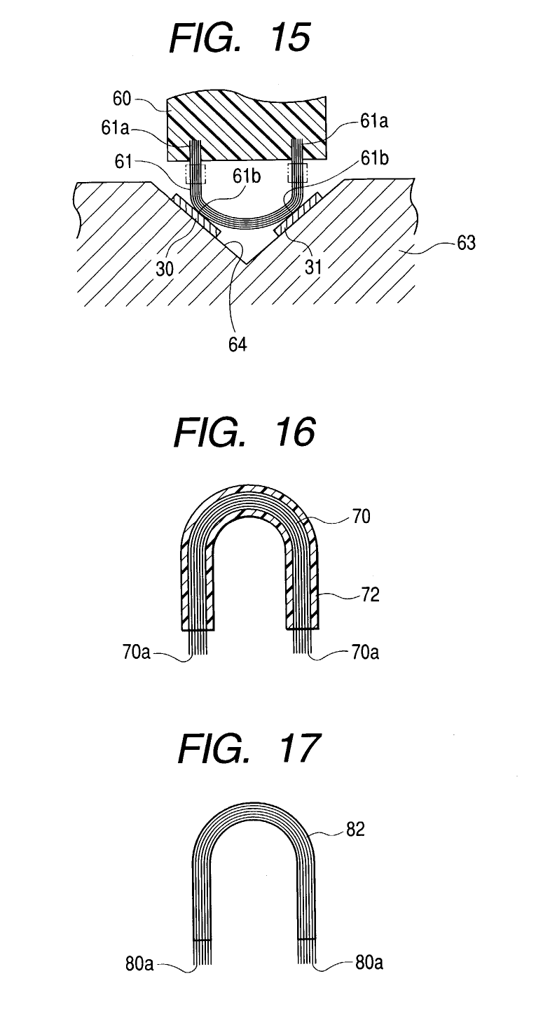

FIG. 15 shows an example of the sliding-type electric component according to a seventh embodiment of the present invention. The contact element in this example is formed by embedding and fixing both ends 61a, 61a of a bundle of carbon fibers (contact element) 61 in a state of being bent into a U-shape within a supporting member (sliding element support) 60, and bent sections 61b, 61b at two points on the midsection of the bundle of carbon fibers 61 are used as sliding portion for the first track 30 and the second track 31. In this example, a groove 64 of a V-shape in lateral cross-section is formed on the upper surface of a base member 63, and the first track 30 and the second track 31 are disposed on the inclined inner surface of the groove 64 so as to face diagonally with each other.

The bundle of carbon fiber 61 constituting the contact element of this example can achieve its intended function by making a sliding movement at the bent sections (sliding portions) 61b, 61b with respect to the first and second tracks 30, 31 in a state of line contact and constructing the sliding-type electric component.

Since the both ends of the bundle of carbon fibers 61 are supported and constrained by the supporting member 60, and bent into a U-shape, the bundle of carbon fibers 61 may be supported in a state in which the both ends are supported. Accordingly, since rigidity of the bundle of carbon fiber may be increased to a higher level in comparison with the bundles of the carbon fibers in various embodiment described above, and thus the possibility of bending or collapse of the bundle of carbon fibers 61 during the sliding movement with respect to the tracks 30, 31 may be reduced.

FIG. 16 shows the sliding contact member according to an eighth embodiment of the present invention. The sliding contact member in this example is characterized in that a bundle of carbon fibers 70 is bent into a U-shape, and the shape of the portion except for the both ends 70a, 70a is maintained by a holding member 72 constructed of a pipe of thermoplastic resin, such as polypropylene, polybutylene terephtalate, nylon, or the like.

In this construction, the contact element can be obtained by inserting the bundle of carbon fibers 70 into a U-shaped molded cavity of a metal mold, insert-molding it in a state of providing a tension to both ends thereof, and partly covering the bundle of carbon fibers 70 by the holding member 72. Preferably, the tips of the bundle of carbon fibers 70 is cut and aligned in this embodiment after molding.

FIG. 17 shows a sliding contact member according to a ninth embodiment of the present invention. The sliding contact member in this example is characterized in that a bundle of carbon fibers 80 is bent into the U-shape, and the shape of the bundle of carbon fibers 80 is maintained by a holding member 82 of a resin impregnating around portion of the bundle of carbon fibers 80 except for the both ends 80a, 80a.

The bundle of carbon fibers 80 in this example may be obtained by impregnating and curing adhesive agent around the bent section in a state in which the bundle of carbon fibers into a U-shape.

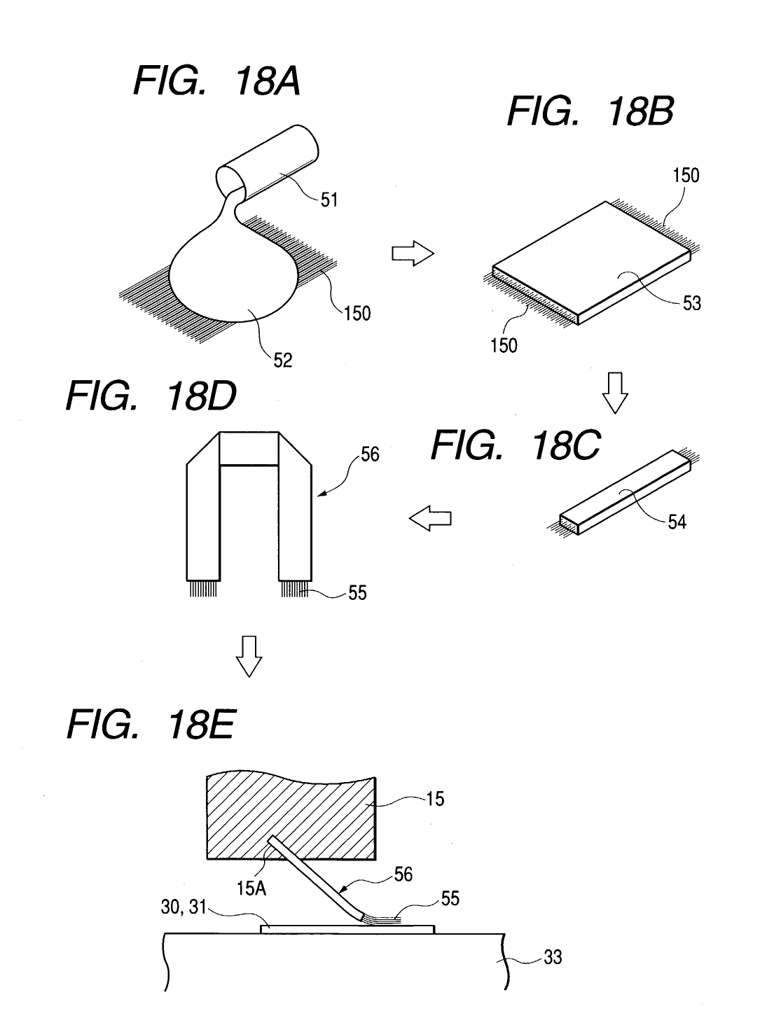

FIG. 18 shows an example of a method for manufacturing a sliding contact member of the type similar to the sliding contact member including the bundle of carbon fibers 47 shown in FIG. 10. As shown in FIG. 18A, resin liquid 52 such as epoxy resin or the like is applied from a container 51 onto thousands of carbon fibers 150 bundled into a flat shape, and is cured into a plate shape, so that a sheet pre-preg 53 shown in FIG. 18B is formed.

In this pre-preg 53, both ends of the bundle of carbon fibers are exposed by a predetermined length, which is required for a sliding movement. Alternatively, when both ends of the bundle of carbon fibers are covered, conductive particles are mixed into the resin liquid in advance, as will be described later.

Preferably, the resin component of the pre-preg 53 is semi-solid state in this stage. The resin liquid used here is not limited to epoxy resin, but may be any resin as long as it is thermosetting type, such as phenol resin, urethane resin, and the like. In the case of thermoplastic resin, it is difficult to inject mold while providing conductivity. However, the thermosetting resin is considered to be suitable because the thermosetting resin can easily be provided with conductivity, can be machined, and can bring the carbon fibers into intimate contact with each other since it is highly contractive. However, the present invention is not limited to the thermosetting resin, and thermoplastic resin may also be employed as a matter of course.

The pre-preg 53 is cut into a rectangular shape to obtain a cutout portion 54, the cutout portion 54 is bent into an angular C-shape as shown in FIG. 18D. Then, the resin component in a semi-solid state is heated to a curing temperature, and dried to make the resin component completely cured. Consequently, a sliding contact member 56 having contact element 55 including the bundle of carbon fibers constrained into the angular C-shape is obtained. The portion of the angular C-shaped contact element 55 on the bent section is inserted into the recess 15A formed diagonally on the sliding element support (supporting member) 15, which has already described above, while allowing the both ends to be projected from the sliding element support 15, a conducting route (electric path) including the contact element 55 and the pair of tracks 30, 31 shown in FIG. 18E is established.

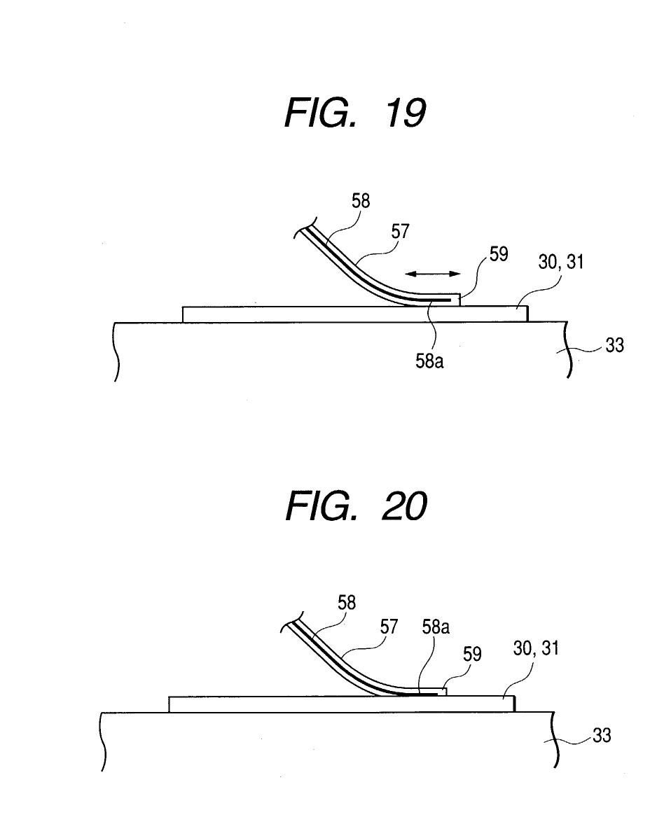

FIG. 19 an enlarged view of a contact element obtained when the bundle of carbon fibers is entirely covered by the resin liquid according to the method of manufacturing shown in FIG. 18, illustrating a state in which the contact element 57 in this embodiment includes a bundle of carbon fibers 58 and a covering layer 59 for covering the periphery thereof, and a side portion 58a of the bundle of carbon fibers 58 abuts against the track 30 or 31 in diagonal close contact via the covering layer 59. The covering layer 59 has a function to hold the carbon fibers in addition to a function to cover the same.

In the contact element 57 in such a construction, conductive material such as conductive carbon nanotube, conductive particulates or the like is mixed into the covering layer 59 of resin in advance.

In other words, when the sliding contact member is manufactured by curing and constraining the bundle of carbon fibers 58 with the resin according to the manufacturing method shown in FIG. 18, the bundle of carbon fibers 58 can be covered by the resin liquid to the both ends. Preferably, the resin liquid used here is already mixed with conductive particles, such as carbon black or the like, and conductive particles having both of reinforcing property and sliding property, such as carbon nanotube (in the order of 10 nm in diameter). The carbon nanotube used here is not specifically limited, and may be the one having the above-described diameter, or an elongated type such as a clew. The conductive particles may be carbon black, or may be precious metal such as silver or gold. In addition, the covering layer itself may be formed of conductive plastic.

In this embodiment, since the resin covering layer 59 covers the periphery of the bundle of carbon fibers 58, rigidity of the bundle of carbon fibers 58 may be enhanced by the covering layer 59, and is tensed by the covering layer 59. Therefore, even when the bundle of carbon fibers 58 is reciprocated, the bundle of carbon fibers 58 will not be change the direction toward the opposite with its outward and inward movement, that is, even when it is moved rightward and leftward along an arrow in FIG. 19, and may be reciprocated in a state in which a state shown in FIG. 19 is maintained, and in which the side portion 58a of the bundle of carbon fibers 58 is kept into abutment with the track 30. Therefore according to the construction in this embodiment, variations in resistance may be obtained without occurrence of hysteresis. Since the carbon fibers are contained inside, it is superior in conductivity in comparison with those covered only by the synthetic resin, and the strength may also be increased.

It is also possible to manufacture the sliding contact member 56 having the contact element 55 having a construction shown in FIG. 18E by covering the bundle of carbon fibers with the resin liquid to the both ends to form a pre-preg, cutting and bending the pre-preg, and then melting the both end portions thereof with a solvent or the like to expose the both end portion of the bundle of carbon fibers.

FIG. 20 shows a state in which the covering layer 59 of the contact element 57 including bundle of carbon fibers 58 according to the previous embodiment is worn by repeated reciprocating movement, and thus the contact element 57 slide with respect to the track 30 in a state in which the bundle of carbon fibers 58 is in contact with the track 30.

In this state as well, as long as the contact element 57 in the previous embodiment is employed, even when the covering layer 59 is worn, the only change is that the bundle of carbon fibers 58 is in contact with the track 30 during sliding movement and the sliding performance is maintained without significant deterioration, so that its intended function is achieved.

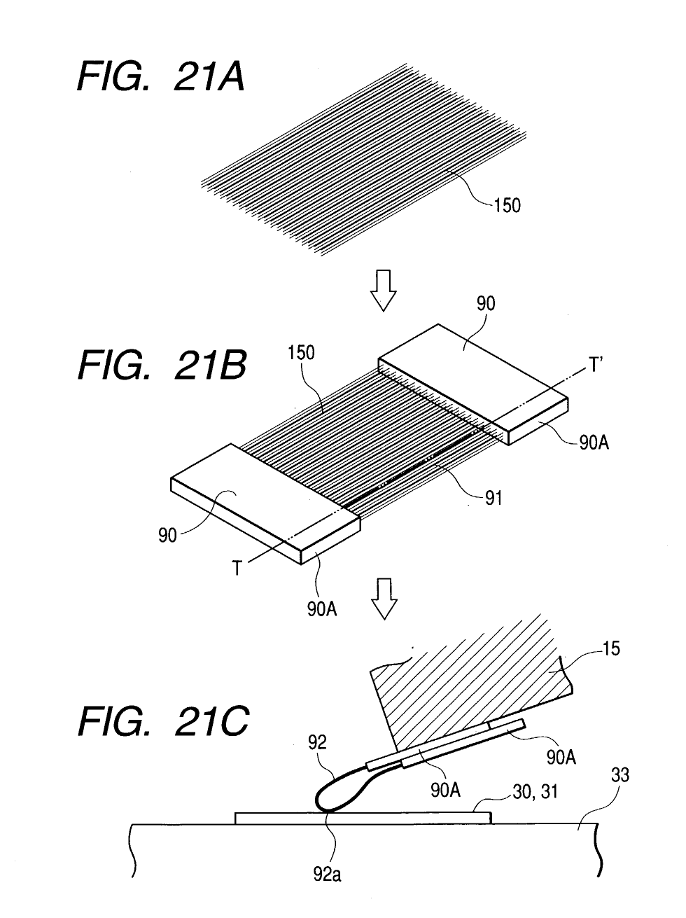

FIG. 21 shows a method of manufacturing and a construction of the sliding contact member according to a tenth embodiment of the present invention. As in the case described in conjunction with FIG. 18A, thousands of carbon fibers 150 bundled into a flat shape is mounted to a metal die, and plate-shaped supporting plates 90, 90 are formed on both sides of the assembly 150 by insert resin molding, and the supporting plates 90, 90 are cut along a cutting line T-T′ shown in FIG. 21B, so that a bundle of carbon fibers 91 in a state of being supported at both ends by the supporting members 90A, 90A. Then, the bundle of carbon fibers 91 can be bent by mounting the supporting portions 90A, 90A on the bottom of a sliding element support 1 one on the other as shown in FIG. 21C by a fixing method such as adhesion, chalking or the like, so that a contact element 92 including a looped bundle of carbon fibers is obtained.

The intended function is achieved by using the side portion 92a at the midsection of the contact element 92 bent into a loop shape as the sliding contact member with respect to the track 30 or the track 31.

In this embodiment, the contact element 92 in this embodiment does not have to straddle the pair of tracks 30 and 31, and can be applied as the sliding contact member sliding independently with respect to the track 30 or the track 31. In this embodiment, the side surface of the carbon fiber can reliably be brought into contact with the conductive pattern. In addition, it serves as a straddle mounted spring, a large load can be applied.

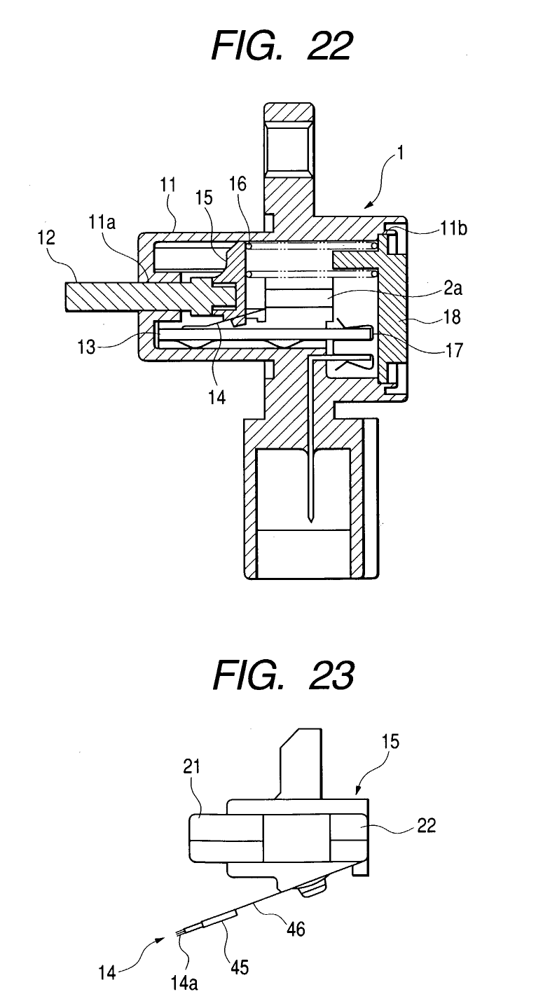

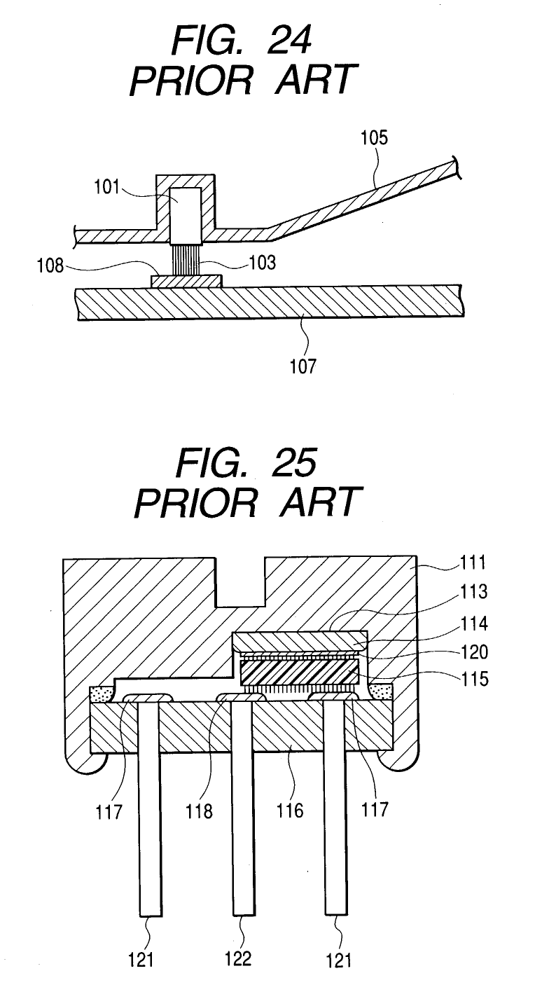

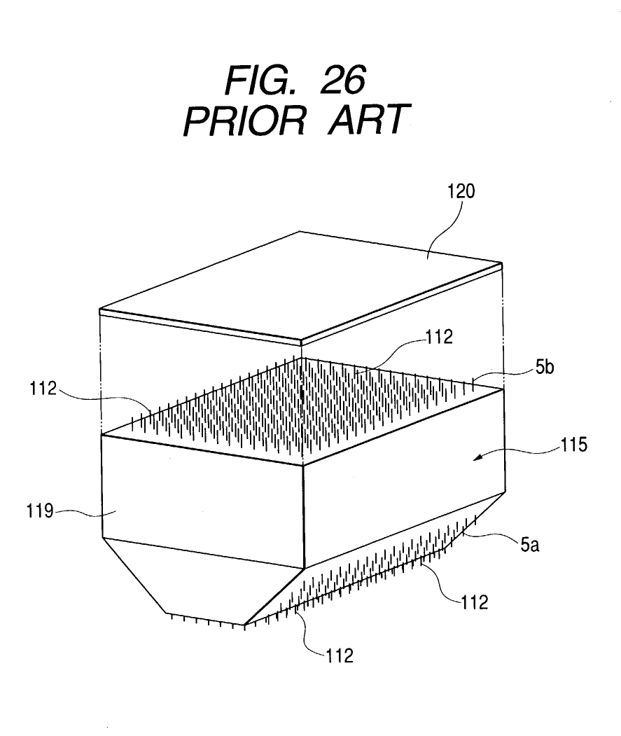

FIG. 22 and FIG. 23 show an example of a sensor for an automotive vehicle having a sliding contact member according to the present invention. A sensor 1 in this embodiment is mounted on the automotive vehicle in the vicinity of the engine, and is used as a sensor for controlling an air-fuel ratio or as a sensor for controlling the recycling amount of exhausted gas. FIG. 22 shows a cross sectional view of the sensor, and FIG. 23 is a side view showing a state in which the sliding contact member is mounted to the sliding element support.

The sensor 1 shown in FIG. 22 includes a casing 11 forming the outer shell, a shaft 12 being shiftable in the lateral direction in FIG. 22 with respect to the casing 11, a base member 13 integrated in the casing 11, a sliding contact member 14 being in sliding contact with the base member 13 including the first track 30 formed of a resistive element formed on the base member 13 and the second track 31 formed of conductive element, a sliding element support (supporting member) 15 for holding the sliding contact member 14, and an external terminal 17 connected to the base member 13.

In the casing 11, the shaft 12 is inserted into a shaft hole 11a formed on one end (left end in FIG. 22), and a cover 18 is mounted to an opening 11b formed on the other end (right end in FIG. 22).

As the sliding contact member 14, the bundle of carbon fiber 14 fixed to the mounting body 46 in the shape of a leaf spring shown in FIG. 9 may be applied as a contact element of the sliding contact member.

The sensor 1 of the construction described above is used in the vicinity of the engine in an automotive vehicle. The sensor 1 detects the position of the shaft 12 provided with the sliding contact member 14, in accordance with the reciprocating sliding movement of the sliding contact member 14 with respect to the base member 13 having the first track 30 and the second track 31, by measuring the output voltage with respect to the input voltage by a circuit connected to the bundle of carbon fibers 14A of the sliding contact member 14 based on the position of the sliding contact member 14 during the sliding movement as in the case of the first embodiment described above, and thus serves as a position detecting sensor. Since the carbon fibers of the bundle of carbon fibers 14 is column shape in the initial state, they come into line contact with the first and the second tracks 30, 31, or come into surface contact with the rough shape on the surface of the first and second tracks 30, 31. When the side surfaces of the carbon fibers are ground in association with the reciprocating sliding movement of the sliding contact member 14, they come into surface contact with the surfaces of the first and the second tracks 30, 31.

The sensor 1 having the construction described above detects the positions of the end portions 14a, 14a of the bundle of carbon fibers 14A in the linear reciprocating movement. When the sensor 1 constitutes a rotating angle sensor, an annular first track and an annular second track having different diameters are concentrically disposed on the upper surface of a disk-shaped base member, the bundle of carbon fibers 14 as a contact element is mounted to a disk-shaped rotatable sliding element support and is disposed so as to straddle the annular first track and the annular second track, so that the contact positions of the ends 14a of the bundle of carbon fibers 14 with respect to the tracks varies in accordance with the rotating angle position of the rotating sliding element support. Therefore, the invention can also be applied to the rotating angle sensor that detects rotating angle based on the output voltage supplied in conjunction with the position as a matter of course.

The sliding contact member according to the present invention is not limited to the resistive element for a sliding movement for the sensor of the automotive vehicle. As a matter of course, it may be applied to various usages as a sensor in a broad sense, such as a sliding resistor for adjusting slidac resistance of acoustical instrument (a sensor for adjustment), a switch (an input sensor), or a rotary encoder (an angular sensor).

In the example described above, the metal pipe, the resin pipe, or adhesive agent is used as a holding member for constraining the bundle of carbon fibers while maintaining the shape thereof. However, means for maintaining the shape of the bundle of carbon fiber may be a holding member formed by bending a channel material of angular C-shape in cross section, or a holding member having a composite structure formed by disposing a bent metal core material for holding the shape in a heat-shrinkable tubing. What is important is that the holding member has a capability to hold the bundle of carbon fibers into a predetermined shape, and the construction and material may be selected arbitrarily.

Although the conductive patterns are disposed on one plane, or in two levels, and the contact element is bent in this embodiment, it is also possible to form the first and the second tracks on the opposing surface, and disposed a linear contact element between them.

The ends 14a of the bundle of carbon fibers 14A do not have to be connected directly to the tracks 30, 31, and it is also possible to cover the tracks 30, 31 with conductive layers and allow the bundle of carbon fibers 14 to slide thereon through the intermediary of the conductive layers. Alternatively, it is also possible to coat the end 14a of individual carbon fiber or of the bundle of carbon fibers 14A with a resin layer containing conductive particles, so that the covering layer slides on the tracks 30, 31.

In the embodiments described above, the pair of patterns 30, 31 are constructed of a combination of the layer of conductive element and the layer of resistive element. However, the construction in which both of the patterns include the layers of resistive element, the construction in which the both of the patterns include the layers of the conductive element, and the construction in which one track includes a comb-shaped conductive pattern and the other track include a pattern of a collector are also applicable.

In such a case, and in each embodiment, the pair of pattern may be constructed in such a manner that a current is input into one pattern and output from the other pattern via the sliding contact, as a matter of course.

What is claimed is:

1. A sliding-type electric component comprising:
a contact element,
wherein the contact element comprises a bundle of carbon fibers, and a sliding portion formed on the side portion thereof, and the sliding portion is capable of linear contact or surface contact with a track of a conductive pattern.

2. A sliding-type electric component according to claim 1 comprising a contact element, wherein the contact element comprises a bundle of carbon fibers bent into a bifurcated shape, and the carbon fibers comprises sliding portions to be slid with respect to a conductive pattern having a pair of tracks on the side portion at both ends on the side opposite to the bent section.

3. A sliding-type electric component according to claim 1, wherein the bundle of carbon fibers is bent in a state in which both ends thereof are supported, and part of the side portion of the bent section serves as a sliding portion.

4. A sliding-type electric component according to claim 3 comprising a contact element, wherein the contact element comprises the bundle of carbon fibers bent into a bifurcated shape, and the carbon fibers comprises sliding portions to be slid with respect to a conductive pattern having a pair of tracks at the portion except for both ends on the side opposite to the bent section.

5. A sliding-type electric component comprising:
a contact element, wherein the contact element comprises a sliding portion to be slid with respect to the track of the conductive pattern, and the sliding portion is formed by covering at least part of a bundle of carbon fibers with a covering layer.

6. A sliding-type electric component according to claim 5, wherein the covering layer is formed of synthetic resin mixed with conductive material.

7. A sliding-type electric component according to claim 5, wherein the side portion of the covering portion serves as a sliding portion to be slid with respect to the track of the conductive pattern.

8. A sliding-type electric component, comprising:
a contact element,
wherein the contact element is a bundle of carbon fibers bent into a bifurcated shape, and the carbon fibers are formed with sliding portions to be slid with respect to a conductive pattern having a pair of tracks at both end on the side opposite to the bent section,
wherein the bundle of carbon fibers as the contact element is covered with a cylindrical holding member at least partly or entirely of the portion thereof except for the sliding portion in a state of being exposed, and
wherein the holding member constrains and integrates the bundle of carbon fibers at least partly.

9. A sliding-type electric component according to claim 8, wherein flat portions are formed at the ends of the holding member positioned at the ends of the bundle of the carbon fibers, the ends of the bundle of the carbon fiber projected from the flat portions serve as sliding portions aligned in a flat shape, and both of the sliding portions are aligned widthwise of the tracks, with respect to which the both of the sliding portions slide respectively.

10. A sliding-type electric component according to claim 8 comprising a contact element, wherein the shape of the bundle of carbon fibers is maintained into a bifurcated plate shape having a intermediate bent section by the holding member.

11. A sliding-type electric component, comprising
a contact element,
wherein the contact element is a bundle of carbon fibers bent into a bifurcated shape, and the carbon fibers are formed with sliding portions to be slid with respect to a conductive pattern having a pair of tracks at both end on the side opposite to the bent section,
wherein the bundle of carbon fibers as the contact element is covered with a holding member formed of resin at least partly or entirely of the portion thereof except for the sliding portion in a state of being exposed, and
wherein the contact element is formed by insert-molding the bundle of carbon fibers into the holding member.
